(19) United States
(12) Patent Application Publication
(10) Pub. No.: US 2010/0304833 A1
(43) Pub. Date: Dec. 2, 2010

(54) Systems, Apparatuses and Methods for Awarding Gaming Payouts

(76) Inventor: Bradley Berman, Minnetonka, MN (US)

Correspondence Address: Hollingsworth & Funk, 8500 Normandale Lake Blvd., Suite 320, Minneapolis, MN, 55437, US

(21) Appl. No.: 12/784,122

(22) Filed: May 20, 2010

Related U.S. Application Data
(60) Provisional application No. 61/181,281, filed on May 26, 2009.

(51) Int. Cl. G06F 17/00

(52) U.S. Cl. 463/20

(57) ABSTRACT

Systems, apparatuses and methods for enhancing payout awards in gaming activities, such as providing additional chances for obtaining a winning payout and/or augmenting payout awards in gaming activities. One exemplary method involves presenting symbols in a plurality of symbol locations; determining whether any predetermined symbol location groups, which are distinct from established paylines in which a symbol paytable identifies winning payouts, respectively include matching symbols therein; and providing a payout amount if one or more of the predetermined symbol location groups respectively includes the matching symbols therein.

### RELATED APPLICATIONS

This application claims the benefit of Provisional Patent Application No. 61/181,281, filed on May 26, 2009, to which priority is claimed pursuant to 35 U.S.C. §119(e) and which is hereby incorporated herein by reference in its entirety.

### FIELD OF THE INVENTION

This invention relates in general to games, and more particularly to systems, apparatuses and methods for providing payout awards in gaming activities.

### BACKGROUND

Many gaming activities, such as slot machine games, involve mechanical or electronic/virtual reel strips having various symbols associated therewith. A paytable is typically provided, which notifies the player of the payout that will be provided when a consecutive number of particular symbols are presented during play. For example, the paytable may indicated that a payout of six credits will be awarded if three consecutive cherry symbols appear along a pre-established payline; twenty credits will be awarded if three consecutive plum symbols appear along a pre-established payline; and so forth. In order for the player to receive a payout, the reels are “spun” (whether mechanically or otherwise randomly selected in an electronic system having a video display), and the symbol combinations presented on established paylines are compared to the possible winning combinations in the paytable. The player receives payouts for any presented symbol combinations, on the established paylines, and match the payout criteria in the paytable.

In the standard manner of obtaining payouts described above, the player will only receive payouts for those symbol combinations occurring on established paylines. If a matching symbol combination occurred in a line of display segments that is not on an established payline (or is on an inactive payline due to the player not providing a wager to play that payline), then the player does not receive a payout for that matching symbol combination.

Another known payout method is generally referred to as a scatter pay. This type of payout is awarded when some minimum number of a certain symbol occurs during game play. For example, a rule may indicate that if three start symbols are presented in any of the display segments in response to a reel spin, the player receives a payout. Therefore, with a scatter pay result, there is no succession of symbols presented, but rather it is a number of a certain symbol in any locations on the viewing area. Thus, the player would not recognize the winning scatter pay event unless he/she knew that the established number of occurrences of the certain symbol on the viewing area will provide a winning payout, or unless the gaming system highlights the winning result. There is no symmetry or other visual alignment that enables the player to immediately recognize a scatter pay as a winning result.

It is desirable to provide captivating gaming opportunities for game player to maintain player interest, particularly where there are multiple chances of winning and/or increasing payout awards. In furtherance of the need to attract participants to particular gaming machines, there is a continuing need to further the excitement and anticipation in the participation of gaming activities. The present invention fulfills these and other needs, and offers advantages over prior art gaming approaches.

### SUMMARY

To overcome limitations in the prior art described above, and to overcome other limitations that will become apparent upon reading and understanding the present specification, the present invention discloses systems, apparatuses and methods for awarding gaming payouts, such as providing additional chances for obtaining a winning payout and/or augmenting payout awards in gaming activities.

In accordance with one embodiment of the invention, a method is provided for presenting symbols in a plurality of symbol locations; determining whether any predetermined symbol location groups, which are distinct from established paylines in which a symbol paytable identifies winning payouts; respectively include matching symbols therein; and providing a payout amount if one or more of the predetermined symbol location groups respectively includes the matching symbols therein.

Methods according to other embodiments include providing a payout amount by providing increasingly higher payout amounts for increasingly higher numbers of the predetermined symbol location groups that respectively include the matching symbols therein.

Methods according to other embodiments further include providing a plurality of the established paylines and the corresponding symbol paytable identifying winning symbol combinations that provide standard payouts for occurrences of the identified winning symbol combinations on the established paylines.

Methods according to other embodiments include providing a payout amount by providing a first multiplier value if one of the predetermined symbol location groups includes the matching symbols, and multiplying the first multiplier value by an amount wagered. In another particular embodiment, providing a payout amount involves providing a second multiplier value if two of the predetermined symbol location groups includes matching symbols, and multiplying the second multiplier value by an amount wagered. In another particular embodiment, the second multiplier value comprises a greater value than the first multiplier value.

Methods according to other embodiments include providing a payout amount by providing a first multiplier value if one of the predetermined symbol location groups includes the matching symbols, and multiplying the first multiplier value by a standard payout resulting from one or more symbol combinations occurring on paylines that correspond to winning symbol combinations on a standard paytable. In yet other embodiments, providing a payout amount involves providing a second multiplier value if two of the predetermined symbol location groups include matching symbols, and multiplying the second multiplier value by the standard payout resulting from one or more symbol combinations occurring on paylines that correspond to winning symbol combinations on a standard paytable. In still other embodiments, the second multiplier value comprises a greater value than the first multiplier value.

Methods according to other embodiments include providing a payout amount by providing respective predetermined payouts for each of the respective symbol location groups that include matching symbols therein.

Methods according to other embodiments include determining whether any predetermined symbol location groups respectively include matching symbols by determining whether each of the symbol location groups respectively includes like symbols therein, regardless of what particular symbol is alike in the respective symbol location group.

Methods according to other embodiments include determining whether any predetermined symbol location groups respectively include matching symbols by determining whether each of the symbol location groups respectively includes like symbols therein, regardless of whether the particular symbol that is alike in the respective symbol location group is available in winning symbol combinations on the established paylines.

Methods according to other embodiments include defining one or more of the predetermined symbol location groups as vertical lines of the symbol locations.

Methods according to other embodiments include defining one or more of the predetermined symbol location groups as horizontal lines of the symbol locations.

Methods according to other embodiments include defining one or more of the predetermined symbol location groups as diagonal lines of the symbol locations.

Methods according to other embodiments include defining one or more of the predetermined symbol location groups as predetermined patterns of the symbol locations.

A method in accordance with another embodiment of the invention includes establishing one or more paylines, on which consecutive like symbols presented in symbol locations and matching those identified via a paytable will produce a winning result; presenting symbols in a plurality of the symbol locations; determining whether a first payout value is awarded based on whether any of the consecutive like symbols were presented on the established paylines that match those identified in the paytable; determining whether a second payout value is awarded based on whether a plurality of any matching symbols was presented in any of a plurality of predetermined symbol location groups, wherein the second payout value is the same regardless of the particular symbol that was matched in its respective symbol location group; and providing a total payout based on at least any determined first payout value and any determined second payout value.

According to other embodiments, the second payout value is mathematically applied to a wager value to provide a total second payout value, and wherein providing a total payout involves providing the total payout based on at least any determined first payout value and the total second payout value.

According to other embodiments, the second payout value is mathematically applied to the first payout value to arrive at the total payout.

Other embodiments involve apparatuses configured to perform the functions identified above and throughout the application.

Still other embodiments involve a computer-readable medium including instructions executable by a processor(s) to perform steps comprising any of the functions identified above and throughout the application.

Another embodiment involves a slot machine having at least a processor configured to perform the functions identified above and throughout the application.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a flow diagram illustrating a representative method in accordance with the invention;

FIG. 2A is a flow diagram illustrating an embodiment of the invention where the symbol location groups are vertical columns;

FIG. 2B illustrates a representative rule set 220 that may be used in connection with embodiments of the invention;

FIG. 2C illustrates a representative embodiment where standard payline/paytable payouts may be provided in addition to special payouts;

FIGS. 3A-3D depicts a display associated with a gaming device in which representative operational embodiments of the present invention are described;

FIG. 4 illustrates a representative embodiment of a casino-style gaming device in which the principles of the present invention may be applied;

FIG. 5 is an example of how payouts in accordance with the invention may be made; and

FIG. 6 illustrates a representative computing system capable of carrying out operations in accordance with the invention.

### DETAILED DESCRIPTION OF EMBODIMENTS OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

As indicated above, some gaming payouts are provided when mechanical or video reels are “spun,” and the presented symbol combinations occurring on established paylines are compared to possible winning combinations in a paytable. The player receives payouts for any presented symbol combinations, on the established paylines, and match the payout criteria in the standard paytable. Thus, the player does not receive payouts for other lines, groups, series, etc., of corresponding symbols that do not occur on an established payline. Scatter pays, as previously noted, may be awarded when some minimum number of a certain symbol occurs during game play. However, with a scatter pay result, there is no succession or pattern of symbols presented, but rather it is a number of a certain symbol in any locations on the viewing area. Thus, the player would not recognize the winning scatter pay event, i.e. it is not immediately apparent, unless he/she knew that the established number of occurrences of the certain symbol on the viewing area will provide a winning payout, or unless the gaming system highlights the winning result. There is no symmetry or other visual alignment that enables the player to immediately recognize a scatter pay as a winning result.

What is needed in the gaming industry are manners of providing winning payout results for “apparent” winning combinations that are otherwise not on established paylines. A player may quickly perceive a series of corresponding symbols as a winning outcome, but then find that the series of corresponding symbols did not fall on any of the established paylines. Further, payouts such as scatter pays do not satisfy this need, as they are asymmetrical and/or do not provide some visual alignment that might otherwise make the user believe he/she has won, such as when a series of corresponding symbols is visually perceived by the player. The present invention fulfills this need and other shortcomings of the prior art.

Generally, the present invention provides systems, apparatuses and methods for providing payout awards in gaming activities. In accordance with one embodiment of the invention, special gaming payout opportunities are provided for symbol combinations that, in one embodiment, are not associated with an established payline(s). The special gaming payout occurring on one or more non-paylines is determined and handled differently than payouts based on symbol combinations occurring on a standard payline. As generally used herein, a “non-payline” refers to a line or other pattern of corresponding symbols that is not an established payline where a number of corresponding symbols would otherwise provide some payout based on a paytable. In one embodiment, one or more series of corresponding (e.g., matching) symbols are presented during a gaming activity on a non-payline. The series of corresponding symbols would not otherwise provide a payout, as the corresponding symbols did not fall on an established payline. In accordance with embodiments of the invention, a special payout can be provided for such occurrences. In one embodiment, the amount of the special payout is based on the number of occurrences of corresponding symbol combinations on such non-paylines, regardless of what the particular corresponding symbols are and/or what the paytable relevance might otherwise be for those symbols. Thus, matching symbols on non-paylines are recognized, regardless of what symbols are matching, and payouts can be made based on how many of such non-payline symbol matches occur. As described more fully below, some embodiments involve providing increasingly higher payouts based on the number of such non-payline symbol matches.

In one embodiment, the invention provides an alternative payout mechanism to a standard payline/paytable mechanism, where awards are granted when like symbols are presented in any predetermined symbol location group, and where the granted award is the same regardless of the particular matching symbol that was presented in the respective symbol location group(s).

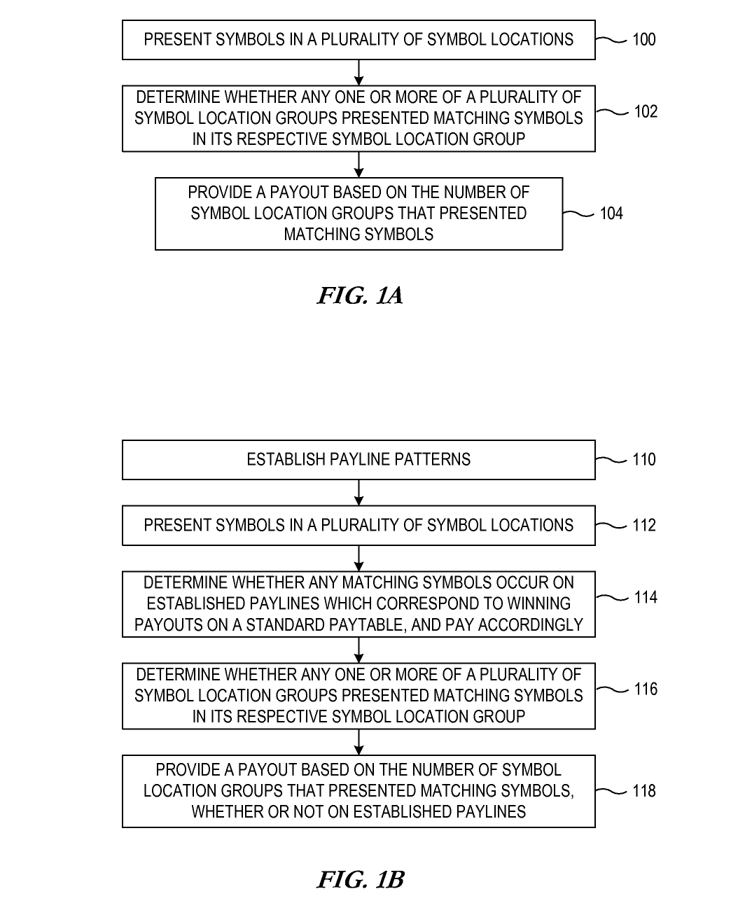

FIG. 1 is a flow diagram illustrating a representative method in accordance with the invention. Symbols are presented 100 in a plurality of symbol locations. This can be done in any fashion. Assume, for example, a 3×5 grid of display segments, where various symbols of a symbol set can be presented in any of the fifteen display segments. The symbols presented can be symbols otherwise used to obtain winning payouts in a standard slot game, which is based on a paytable of various payouts depending on which symbol is consecutively presented on a pre-established payline. Such symbols are presented randomly in the display segments. It should be noted that “randomly” in this sense does not require or imply pure randomness; e.g., the symbols may be, and often are, weighted in some fashion. Thus, “random” or “randomly” as used herein refers to at least some degree of randomness.

After presentation of the symbols, some embodiments involve determining whether any winning symbol combinations, based on the standard paytable(s) of the game, may have occurred. If so, a payout(s) may be provided in the normal fashion. In accordance with embodiments of the present invention, a different type(s) of payout based on different criteria may be provided. As a particular example, in the embodiment of FIG. 1, it is determined 102 whether any one or more of a plurality of symbol location groups presented matching symbols in its respective symbol location group. A “symbol location group” as used herein may be any line or other grouping of symbol locations, which in some embodiments do not correspond with an otherwise established payline, while in other embodiments it may also be an established payline. In one example, the established paylines may all move from left to right, while the “symbol location groups” in accordance with the present invention may involve vertical columns on the display segment grid that are otherwise not also established paylines. If any of these vertical columns (or other symbol location groups) present corresponding symbols, a payout may be provided 104. In one embodiment, the payout is the same regardless of which symbols matched in that vertical column or other symbol location group, although varying payouts based on symbol type may also be used.

One embodiment involves providing 104 a payout based on how many of such symbol location groups had corresponding symbols presented therein. For example, if the symbol locations groups are defined as vertical columns of display segments, and each of the display segments of one of the vertical columns is filled with the same symbol, the player receives a first payout. The payout may be a particular number of credits, or may be a value to be applied to some other amount such as a mathematical function (e.g., multiplier). Examples of such payouts include a set number of credits, return of the original wager, a multiplier to be applied to standard paytable winnings, a multiplier to be applied to the original wager, etc. As indicated above, one embodiment provides the same payout for filling such a vertical column, regardless of which symbol occurred in each of the display segments of that vertical column.

If, however, two vertical columns are filled (e.g., one vertical column filled with symbol-X, and another filled with symbol-Y or again with symbol-X), then a higher payout provided in accordance with one embodiment. For example, where two columns are respectively filled (or reach some minimum number of consecutive display segments) with matching symbols, the payout may be higher than if only one column was filled. Examples include twenty times (20×) the player's bet, or some established credit award that is higher than if only one column was filled, etc. In one embodiment, filling a first column provides an award that is 1× the player's original wager; i.e. the player gets his/her wager back. In another embodiment, filling two columns provides an award that is, say, 22× the player's original wager. Filling three columns may provide an even higher award.

As can be seen, this representative payout methodology provides players with payouts for what may be perceived by the player as a possible win, but in one embodiment is not on an established payline(s) to which a payout based on the standard paytable would be made. In some embodiments, the payout is some multiplier of the player's initial wager, and therefore forms an entirely different manner of obtaining payouts relative to the standard payline/paytable payouts. In other embodiments, the payout need not be based on a multiplier of the player's wager, but can alternatively be based on a set of payout rules different than those of the established payline/paytable payouts. In some embodiments, the payout for filling a column is the same regardless of which symbol of the symbol set matched—e.g., a 1× multiplier of the initial bet may be provided if one symbol location group (e.g., vertical column) was filled with cherry symbols, star symbols, etc. Thus, in such an embodiment, the particular symbol used to fill the symbol location group(s) is not of particular relevance, but rather what is relevant is that the column was filled with matching symbols.

FIG. 1B is a flow diagram of another embodiment of a method in accordance with the present invention. Standard payline patterns are established 110. For example, five cherry symbols on an established payline may return ten credits to the player; five plum symbols on an established payline may return twenty credits to the player, etc. Thus, the payline patterns of block 110 represent standard payline/paytable criteria that are used to identify winning payouts on a slot game.

Symbols are randomly presented 112 in a plurality of the symbol locations. In a standard fashion, it may be determined 114 whether any matching symbol combinations occur on the established paylines that correspond to winning payouts on a standard paytable. If so, the player is paid accordingly. In accordance with the illustrated embodiment, it is also determined 116 whether any one or more of a plurality of symbol location groups (e.g., predefined vertical columns, rows, diagonals, patterns, etc.) presented matching symbols in its respective symbol location group. A payout 118 is provided for presentation of matching symbols in the symbol location groups, whether or not these matching symbols in symbol location groups also fell on established paylines. Further, the payout 118 may be based on the number of (i.e., how many) symbol location groups (e.g., vertical columns of display segments) were presented with matching symbols. The payout 118 may be provided in addition to any standard payout 114 provided as a result of winning symbol combinations on established paylines, or may be provided even where the player received no standard payout 114 on any of the established paylines. Thus, some embodiments may provide a winning payout on an established payline to which a standard paytable payout may also be made, but provides a special payout based on the pay rules in accordance with the invention in addition to, or in lieu of, any standard payout also provided by way of the established paylines and paytable.

As indicated above, one embodiment of “non-paylines” may be vertical columns of display segments. In such an embodiment, established paylines in which symbol combinations are compared to a paytable do not include paylines of vertical columns. For example, assume there are three established paylines in a 3×5 grid, where the established paylines are the three horizontal rows defined by the 3 row by 5 column grid. Under normal circumstances, an occurrence of three matching symbols in any column would provide no payout, as there is no established payline. In accordance with one embodiment of the present invention, a special payout can be provided if a column (or partial column if so defined) is filled with the same symbol, regardless of which symbol is actually presented. For example, the player's bet may be refunded, i.e. a 1× multiplier times the player's wagered bet, if any of the five columns of the 3×5 grid are filled with a common symbol, regardless of what the particular matching symbol actually is.

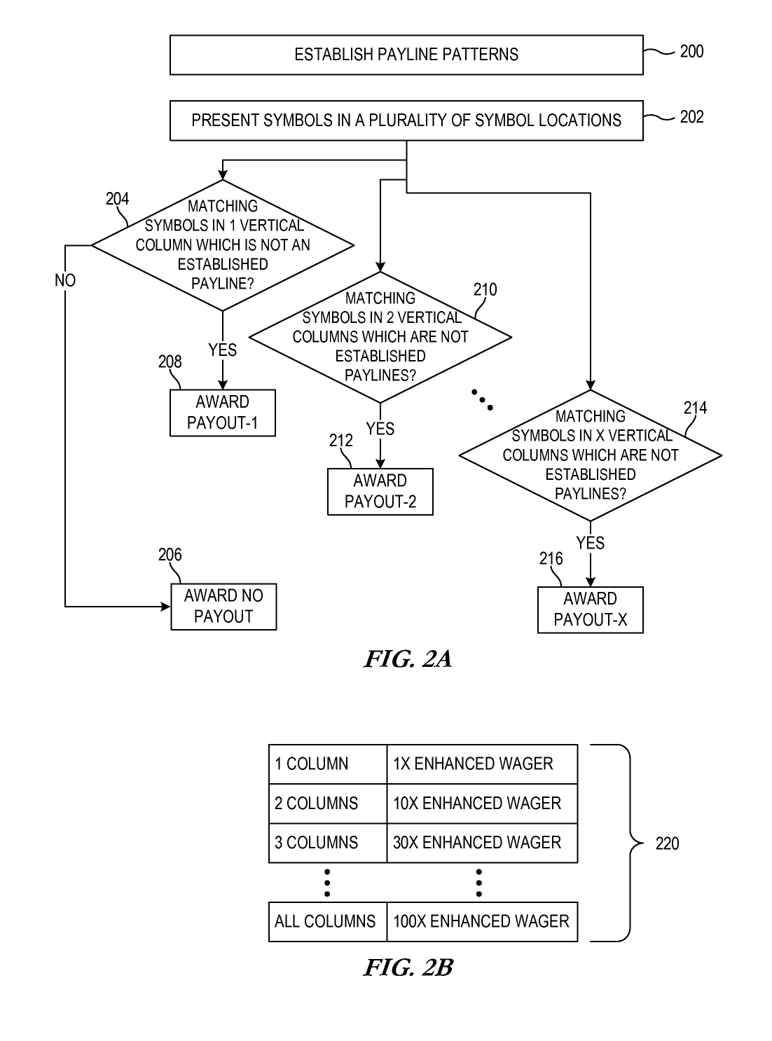

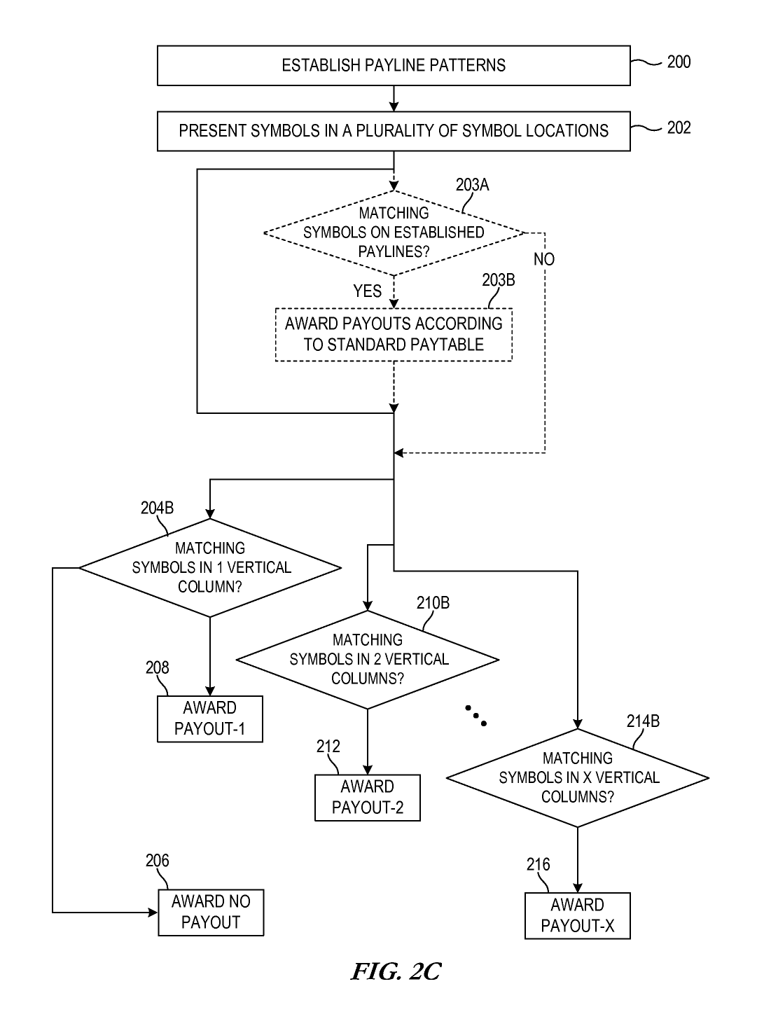

FIG. 2A is a flow diagram illustrating an embodiment of the invention where the symbol location groups are vertical columns as described above. Standard payline patterns may be established 200 for the standard game, and symbols are presented 202 in a plurality of the symbol locations. For example, the mechanical or virtual reels may be spun to randomly present symbols in the symbol locations. If, as determined at decision block 204, that no symbols in vertical columns match, then no special award is paid out as depicted at block 206 (although an award in the established payline/paytable may still be awarded if appropriate). If, as determined at decision block 204, one vertical column includes any matching symbols, where in this embodiment the vertical column is not on an established payline, the player is awarded with the special payout 208. Similarly if, as determined at decision block 210, two columns are respectively filled with matching symbols, then a different award may be paid out 212. In one embodiment, the second payout award 212 is higher than the first payout award 208 since two columns were filled with matching symbols. It should be recognized that each column may have different matching symbols; e.g., the first column with matching symbols may all be star symbols, while the second matching symbols may all be cherry symbols (or even may all be star symbols). Thus, in one embodiment, a column having matching symbols is what triggers the special award, rather than what the particular symbols are in each respective column.

Depending on the number of columns, each filled column may provide additional special awards. For example, if, as determined at decision block 214, there are matching symbols in X vertical columns which are not established as paylines in the standard payline/paytable portion of the game, then an award of payout-X may be provided 216. Again, in one embodiment, in one embodiment, the X^{th} payout award 216 is higher than the previous payout awards 208, 212, etc., since a greater number of columns were filled with matching symbols.

FIG. 2B illustrates a rule set 220 that may be used for an embodiment such as that of FIG. 1A, 1B or 2A. Referring to FIGS. 2A and 2B as an example, if one column is filled, the special payout 208 is a multiplier of 1× to be multiplied by the initial wager. In one embodiment, the player makes an additional wager to be eligible for the special payout vertical column payout (in addition to the standard payline/paytable wagers), which is referred to as an “enhanced wager” for purposes of FIG. 2B. For example, if the player wagered thirty credits for the standard payline/paytable wager, he/she may wager an addition five credits to be eligible for column pays in accordance with the present invention. Thus, in this example, the enhanced wager would be thirty-five credits. The award 208 in such an embodiment would be 1×35, or thirty-five credits. If the player filled two columns, the embodiment of FIGS. 2A/2B would result in a special payout 212 of 10× the enhanced wager, or 350 credits, etc.

Any rule set may be utilized, and the rule set 220 is provided as an example only. For example, the multiplier may be applied to the original payline/paytable wager only (e.g., 30 credits in the above example), rather than the enhanced wager (e.g., 35 credits on the above example). Alternatively, the rule set may provide particular credit amounts for each special payout 308, 212, 216, thereby providing an entirely different way for a player to win a payout relative to the standard payline/paytable manner of winning a payout. The rule set 220 may alternatively be a multiplier or other mathematical function applied to a winning payout of the standard payline/paytable; e.g., if the player matched five star symbols on an established payline to win a standard payout of ten credits, and the “1 column” multiplier was 2×, then the player would receive 2×10, or 20 credits. Any desired rule set 220 may be utilized to provide a different manner of obtaining payouts relative to the standard payline/paytable payout methodology.

The flow diagram of FIG. 2C illustrates another representative embodiment. Reference numbers analogous to those of FIG. 2B remain the same in FIG. 2C. The example of FIG. 2C illustrates that standard payline/paytable payouts may be provided in addition to the special payouts in accordance with the present invention, as depicted by blocks 203A and 203B. Particularly, if 203A the player receives matching symbols on established paylines, payouts will be awarded 203B according to the standard payline/paytable.

In the embodiment of FIG. 2C, the special payouts in accordance with the present invention do not have to occur on non-paylines, i.e., they can also occur on portions of active paylines, on non-active paylines (e.g., standard paylines not wagered on by the player), etc. Particularly, if matching symbols occur on one symbol location group (a vertical column in this example) as determined at decision block 204B, then the player is awarded with the payout 208, which may possibly be in addition to any payout 203B provided in connection with the standard payline/paytable symbol combinations. In this embodiment, the payout 208 may occur even if 204B the matching symbols occurred on some portion or all of an established payline. As described in connection with FIG. 2B, additional payouts 212, 216 may occur where more than one vertical column is respectively filled with matching symbols.

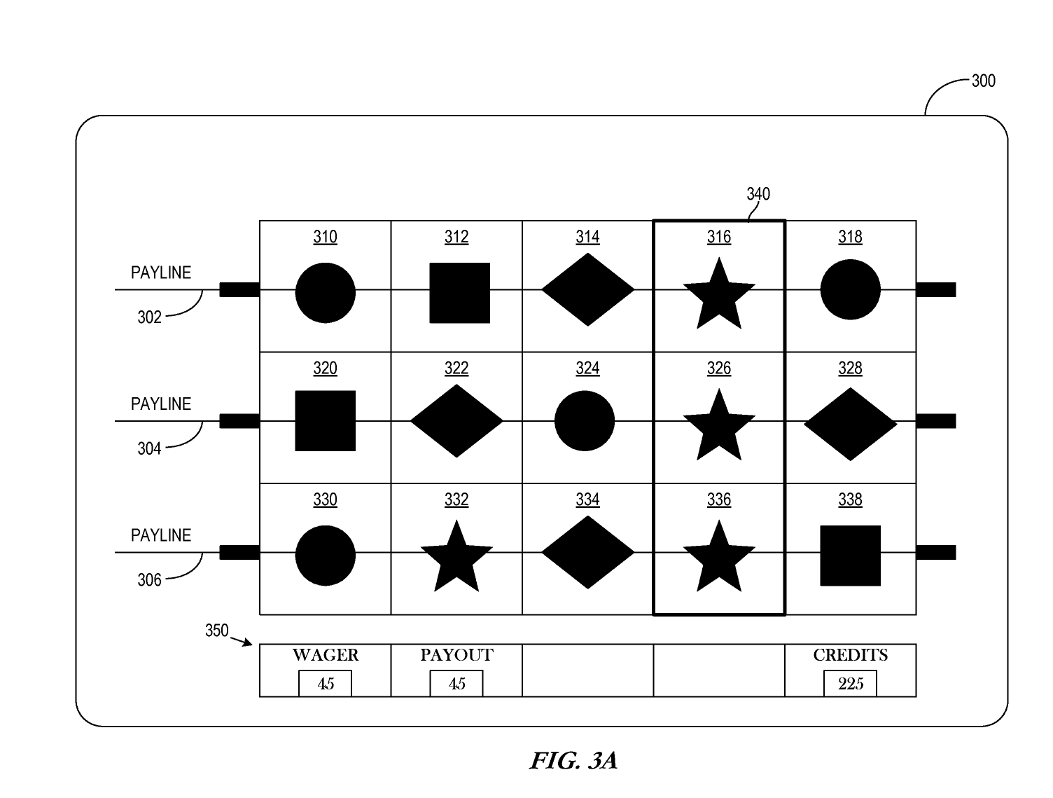

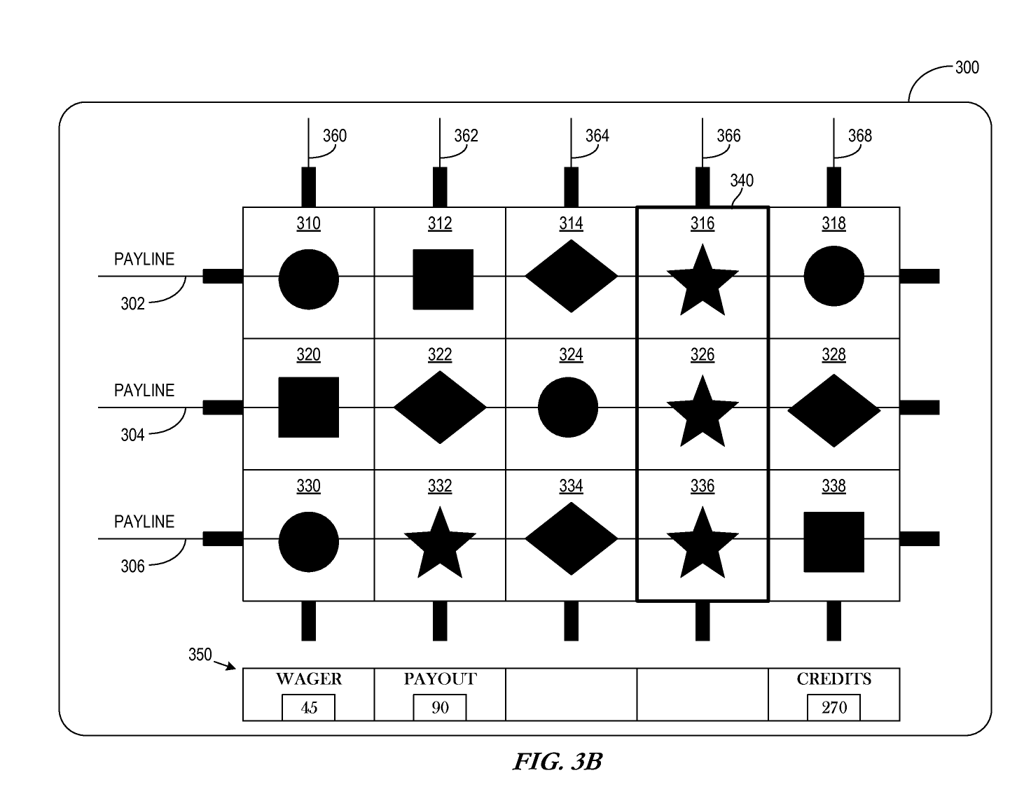

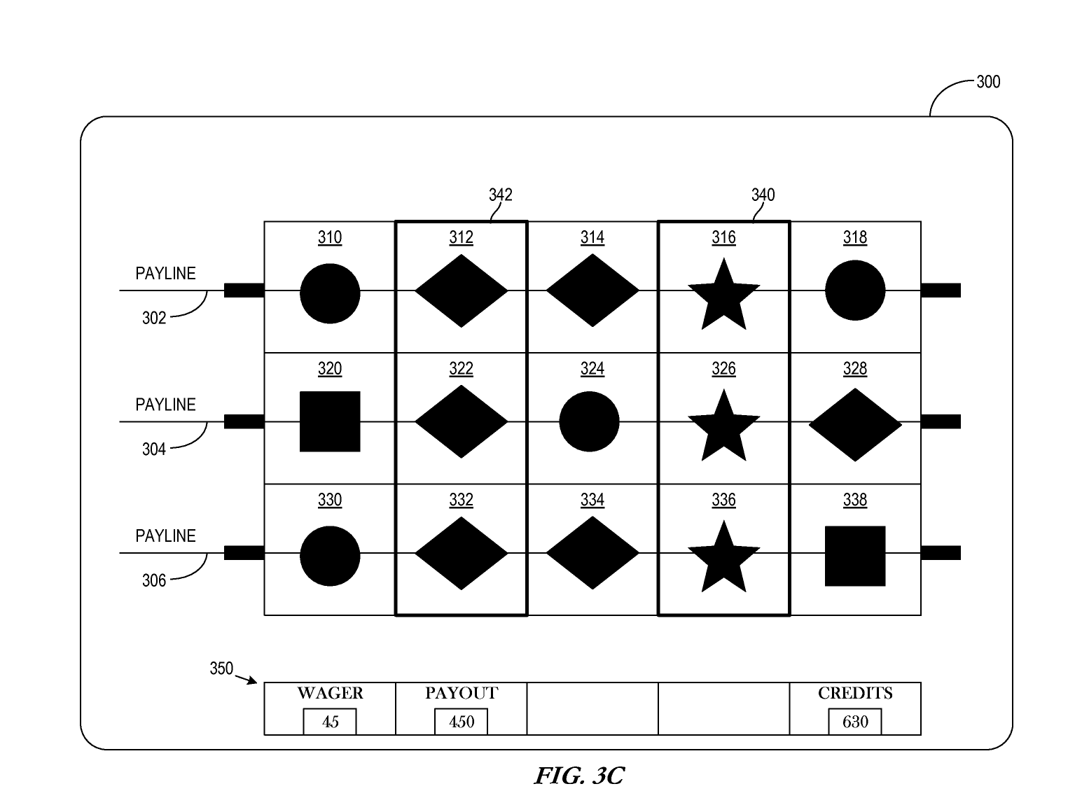

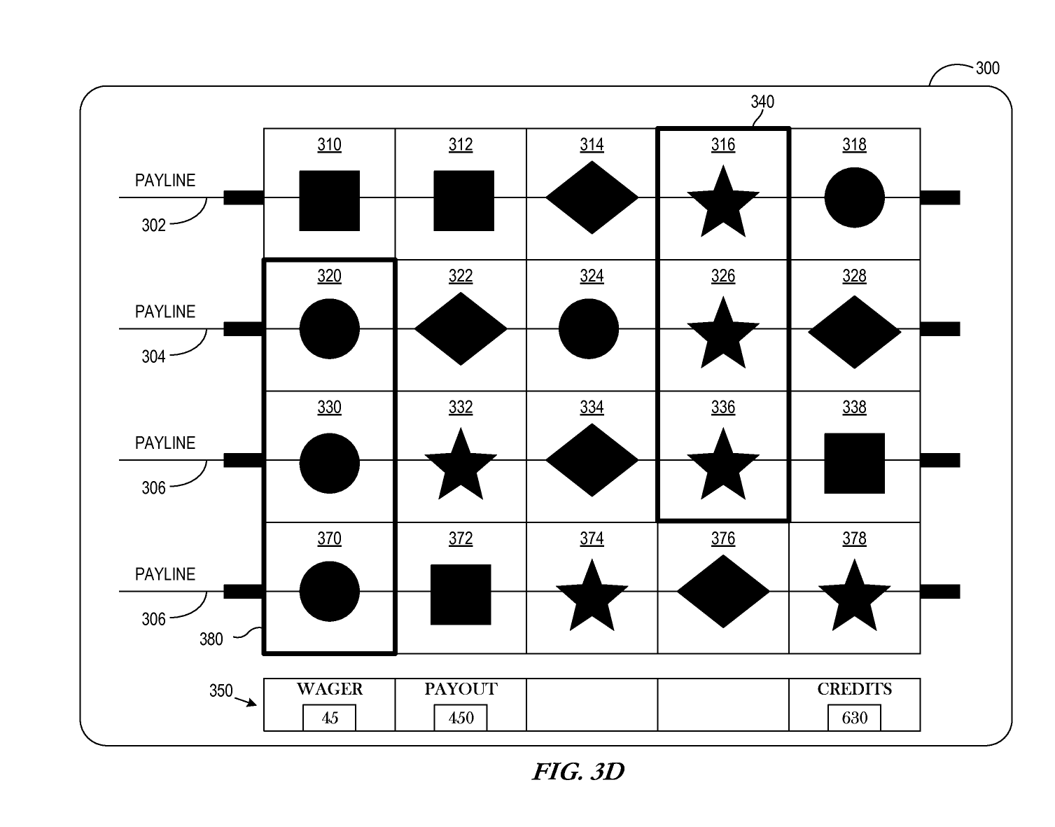

FIG. 3A illustrates a representative display 300 associated with a gaming device in which the principles of the present invention may be utilized. In the illustrated embodiment, the symbol location groups are defined as vertical columns. Thus, the special payout of the invention applies to any of the vertical columns of the 3×5 grid of display segments, where the grid includes fifteen display segments 310, 312, 314, 316, 318, 320, 322, 324, 326, 328, 330, 332, 334, 336 and 338. Any size grid and/or number of display segments may be used in connection with the present invention. Further, while FIG. 3A involves vertical columns as the symbol location groups, the symbol location groups may be any pattern (e.g., vertical columns, horizontal rows, diagonal lines, and/or other predetermined patterns of display segments).

In the illustrated embodiment, there are three established paylines 302, 304, 306. Thus, a standard slot game may be played where a paytable (not shown) is used to determine whether the symbol combinations falling on paylines 302, 304 and/or 306 provide a standard winning payout. In accordance with the invention, a special payout may also or instead be provided where matching symbols occur in one or more of the symbol location groups, which are vertical columns of display segments in the illustrated embodiment. FIG. 3A depicts that three star symbols occurred in the display segments 316, 326, 336 which is a vertical column 340. In the illustrated embodiment, obtaining matching symbols in any vertical column provides a payout of forty-five credits, which is a return of the player's wager of forty-five credits, as shown at the wager/payout display 350. Thus, whether or not the player had obtained a standard payout on a payline 302, 304, 306, the player is still eligible to win the column pays in accordance with the invention. As indicated above, some embodiment require an additional wager by the player to become eligible for the column pay or other special payout provided by matching symbols in one or more symbol location groups.

FIG. 3B utilizes like reference numbers to those of FIG. 3A where appropriate. In the example of FIG. 3B, a greater number of established paylines are utilized. In this embodiment, one or more of the established paylines are on vertical columns, as shown by additional paylines 360, 362, 364, 366, 368. Thus, a special payout for receiving matching symbols on a symbol location group 340 may, in some embodiments, be provided even if that symbol location group is partly or wholly provided on an established payline 366. In the illustrated embodiment, the player could receive a payout for obtaining a standard payout for matching symbols on payline 366, while also receiving a special payout for obtaining matching symbols in the symbol location group 340, which just so happens to correspond to a standard payline 366 in the example of FIG. 3B. In one embodiment the special payout for obtaining matching symbols in the symbol location group 340 may provide a multiplier (e.g., 2×) of any wager placed by the player, or of a winning payout on the standard paylines 302, 304, 306, 360, 362, 364, 366, 368, or other defined payout.

FIG. 3C utilizes like reference numbers to those of FIGS. 3A and 3B where appropriate. In the example of FIG. 3C, the player matched symbols in two different symbol locations groups (columns, in this example). Particularly, the player matched three diamond symbols in the column 342 formed of display segments 312, 322, 332, and three star symbols in the column 340 formed of display segments 316, 326, 336. In one embodiment, the payout is higher than that of filling only one column with matching symbols. In still another embodiment, the higher payout is greater than linearly higher with increasing numbers of filled symbol location groups, and may be exponentially higher. In the illustrated embodiment, the payout for filling two columns 340, 342 is ten times the original wager of forth-five credits, or four hundred fifty credits total. The payout may increase even further if a third, fourth, etc., column was filled with matching symbols.

In still other embodiments, the payout may be further increased if the matching symbols in multiple columns are all the same symbols. For example, in one embodiment, if all six symbols in the display segments 312, 322, 332, 316, 326, 336 were star symbols, the payout may be 20× the original wager rather than 10× the original wager.

FIG. 3D utilizes like reference numbers to those of FIGS. 3A, 3B and 3C where appropriate. In the example of FIG. 3D, the symbol location groups need not be full lengths of the columns, rows, diagonals, and/or whatever other patterns were identified as the symbol location groups. In the illustrated embodiment, the symbol location groups are columns of at least three matching symbols on non-paylines. Thus, the special payout in accordance with the invention is provided for the three matching star symbols in display segments 316, 326 and 336 of partial column 340, and for the three matching circle symbols in display segments 320, 330 and 370 of partial column 380. The embodiment of FIG. 3D is an example simply to show that any patterns of symbol location groups on non-paylines may be used. Other embodiments alternatively allow any patterns of symbol location groups on otherwise established paylines to be used as well.

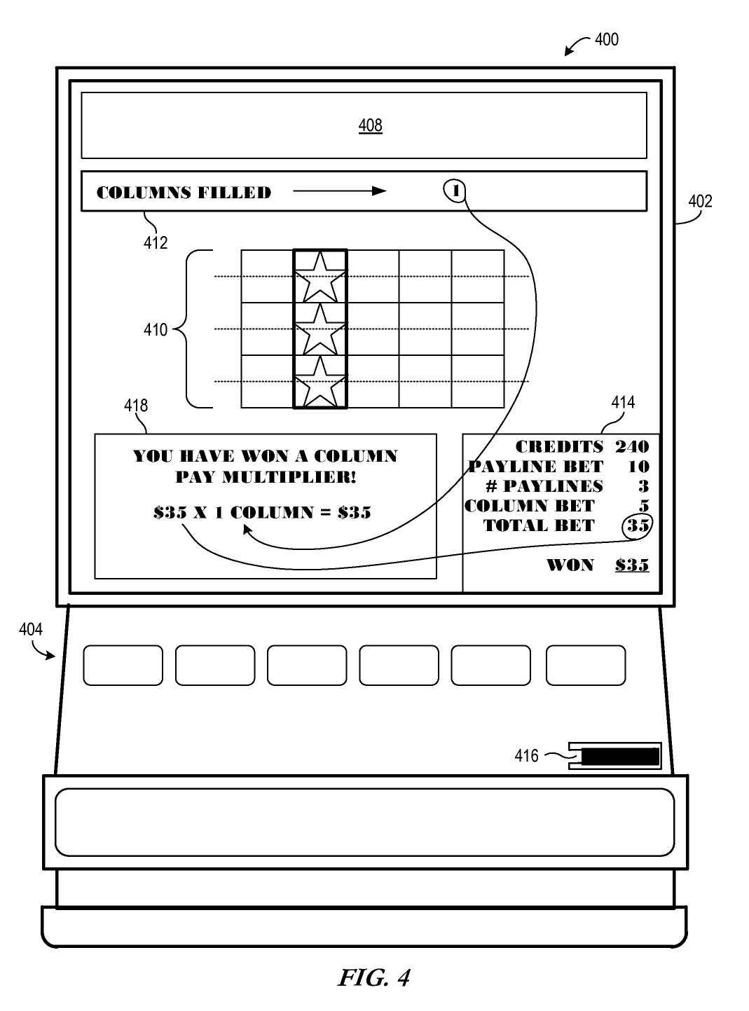

The present invention may be used in connection with slot machines, computing devices and/or other gaming devices. FIG. 4 illustrates a representative embodiment of a casino-style gaming device in which the principles of the present invention may be applied. For purposes of explanation, the description of the gaming device is FIG. 4 is provided in terms of a kiosk or “slot machine” 400. However, the present invention is analogously applicable to other computer-based systems.

The illustrated gaming machine 400 includes a computing system (not shown) to carry out operations according to the invention. The illustrated gaming machine 400 includes a display 402, and a user interface 404, although some or all of the user interface may be provided via the display 402 in touch screen embodiments. The user interface 404 allows the user to control and engage in play of the gaming machine 400. The particular user interface mechanisms associated with user interface 404 is dependent on the type of gaming machine. For example, the user interface 404 may include one or more buttons, switches, joysticks, levers, pull-down handles, trackballs, voice-activated input, or any other user input system or mechanism that allows the user to play the particular gaming activity. The user interface 404 may allow the user to enter coins, bills, or otherwise obtain credits through vouchers, tokens, credit cards, tickets, etc. Various mechanisms for entering such vouchers, tokens, credit cards, coins, tickets, etc. are known in the art. For example, coin/token input mechanisms, card readers, credit card readers, smart card readers, punch card readers, and other mechanisms may be used to enter wagers. It is through the user interface 404 that the user can initiate and engage in a gaming activity in accordance with the invention. For example, the user can use the user interface 404 to selectively pick symbol location groups in which to activate, and may make gaming decisions (e.g., bet max, bet special payout, etc.) that will otherwise make the user eligible for such a feature. While the illustrated embodiment depicts various buttons for the user interface 404, it should be recognized that a wide variety of user interface options are available for use in connection with the present invention, including pressing buttons, touching a segment of a touch-screen, entering text, entering voice commands, or other known user entry methodology. The particular user interface mechanism utilized is not relevant to the present invention.

The display device 402 may include one or more of an electronic display, a mechanical display, and fixed display information such as information such as paytable information associated with a glass/plastic panel 408 on the gaming machine 400. The winning symbol combinations and/or other indicia associated with the play of the game may be presented via mechanical and/or electronic display mechanisms, as depicted in the gaming area 410. In the illustrated embodiment, the number of symbol location groups meeting the rule set is depicted at block 412.

A display segment or panel 414 may also be provided to display information such as the accumulated credits, current bet amount such as “10” credits per payline (where credits may represent, for example, coins, tokens, dollars, etc.), the number of paylines played, the special wager (if any) to be eligible for the column pay or other symbol location group feature, total bet, the number of credits paid out or “won” on a particular play, etc. In the illustrated embodiment, the player wagered ten credits on each of three paylines, plus five credits to be eligible for a “column pay” feature in accordance with the invention, for a total wager of thirty-five credits. A wager acceptor 416 is operative to receive wager tokens, coins, bills, credit/debit cards, coupons, smart cards, prepaid casino cards, electronic fund transfer (EFT), tickets, and the like.

In the illustrated embodiment, the user is shown to have received a winning symbol combination of three star symbols in a column that is not otherwise an established payline as shown via the gaming area 410. In one embodiment, the player is notified that he/she has won a column pay, such as shown in display area 418. In the illustrated embodiment, the player's current winning amount of $35 results from winning one column pay which is a 1× multiplier of the player's total bet of $35, for a winning payout of $35.

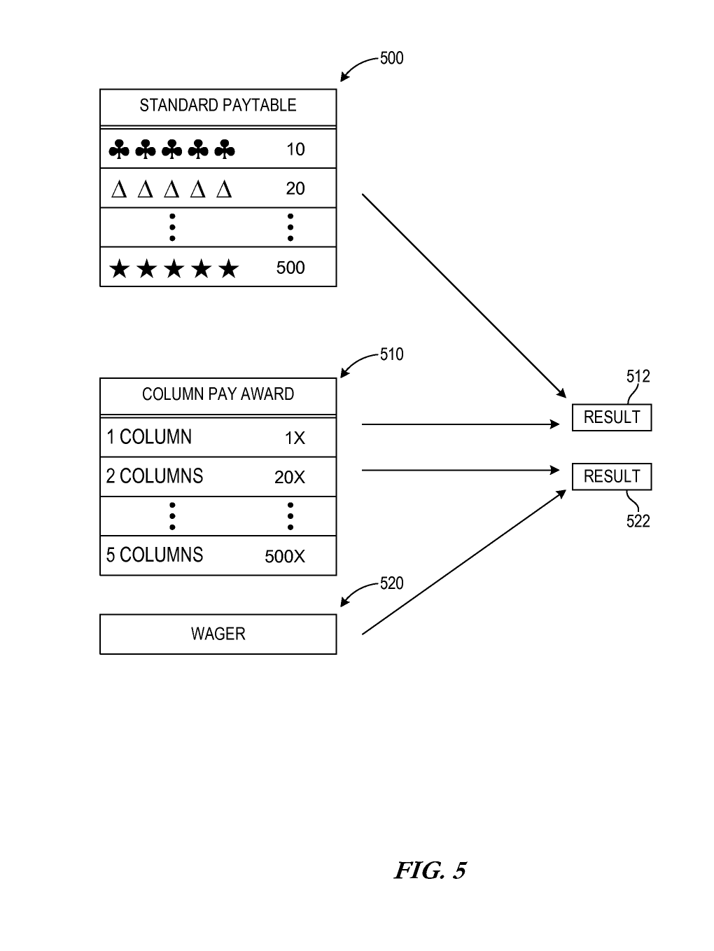

FIG. 5 is an example of how payouts in accordance with the invention may be made. The few examples of FIG. 5 are provided for purposes of example only, and is clearly not an exhaustive list. In one embodiment, the resulting column pay award 510 (or other symbol location group award) is a multiplier to be applied to an amount otherwise won on a current, past or future award on a standard payline(s) as determined by the standard paytable 500, which provides a result 512. In another embodiment, the resulting column pay award 510 (or other symbol location group award) is a multiplier to be applied to the player's wager 520, which provides a result 522. These and/or other manners of providing a separate payout, or an augmented payout relative to other amounts (e.g., wagers, standard payline wins, etc.) are available in connection with the present invention.

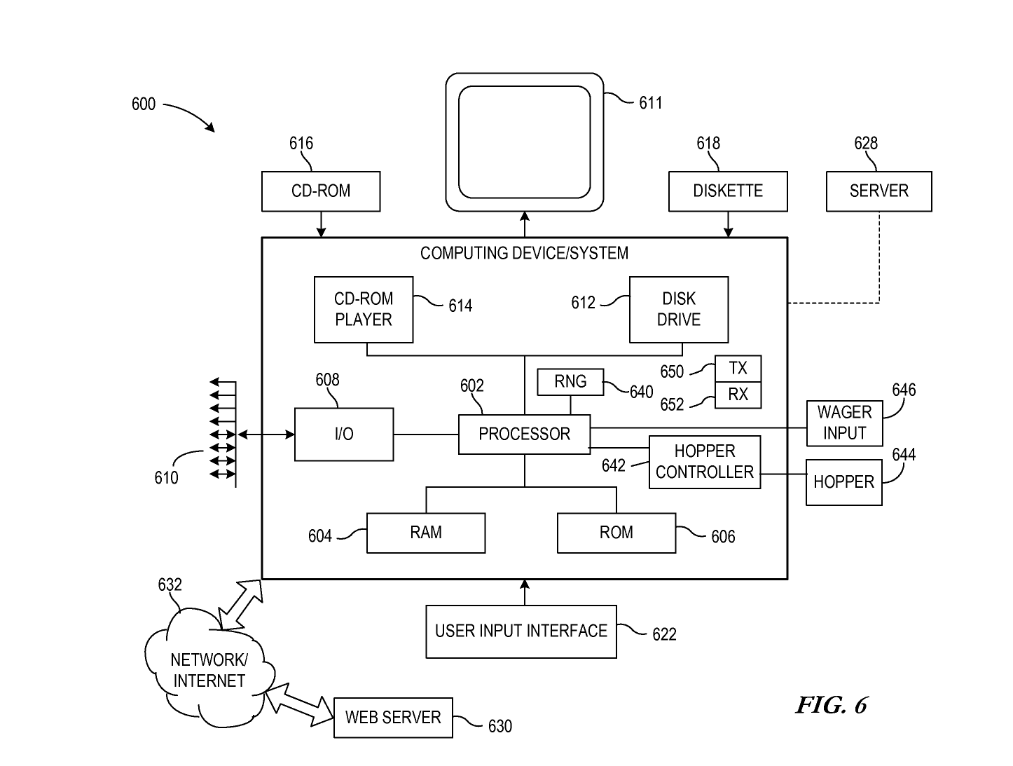

As may now be readily understood, the device 400 of FIG. 4 may be programmed to play various embodiments of the invention. The present invention may be implemented as a casino gaming machine such as a slot machine or other special purpose gaming kiosk as described in FIG. 4, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 6.

Hardware, firmware, software or a combination thereof may be used to perform the various gaming functions, display presentations and operations described herein. The functional modules used in connection with the invention may reside in a gaming machine as described, or may alternatively reside on a stand-alone or networked computing device/system. The computing structure 600 of FIG. 6 is an exemplary computing structure that can be used in connection with such electronic gaming machines, computers, or other computer-implemented devices to carry out operations of the present invention.

The example computing arrangement 600 suitable for performing the gaming functions in accordance with the present invention typically includes a central processor (CPU) 602 coupled to random access memory (RAM) 604 and some variation of read-only memory (ROM) 606. The ROM 606 may also represent other types of storage media to store programs, such as programmable ROM (PROM), erasable PROM (EPROM), etc. The processor 602 may communicate with other internal and external components through input/output (I/O) circuitry 608 and bussing 610, to provide control signals, communication signals, and the like.

Chance-based gaming systems such as slot machines, in which the present invention is applicable, are governed by random numbers and processors. A display device 611 is used to display the gaming activity as facilitated by one or more random number generators (RNG). RNGs are well-known in the art, and may be implemented using hardware, software operable in connection with the processor 602, or some combination of hardware and software. The present invention is operable using any known RNG, and may be integrally programmed as part of the processor 602 operation, or alternatively may be a separate RNG controller 640.

The computing arrangement 600 may also include one or more data storage devices, including hard and floppy disk drives 612, CD-ROM drives 614, and other hardware capable of reading and/or storing information such as DVD, FLASH drives, etc. In one embodiment, software for carrying out the operations in accordance with the present invention may be stored and distributed on a CD-ROM 616, diskette 618, DVD, FLASH device or other form of media capable of portably storing information. These storage media may be inserted into, and read by, devices such as the CD-ROM drive 614, the disk drive 612, etc. The software may also be transmitted to the computing arrangement 600 via data signals, such as being downloaded electronically via a network, such as the Internet. Further, as previously described, the software for carrying out the functions associated with the present invention may alternatively be stored in internal memory/storage of the computing device 600, such as in the ROM 606.

The computing arrangement 600 is coupled to the display 611, which represents a display on which the gaming activities in accordance with the invention may be presented. The display 611 may be any type of known display or presentation screen, such as LCD displays, plasma display, cathode ray tubes (CRT), etc. Where the computing device 600 represents a stand-alone or networked computer, the display 611 may represent a standard computer terminal or display capable of displaying multiple windows, frames, etc. Where the computing device is embedded within an electronic gaming machine (see FIG. 4), the display 411 corresponds to the display screen of the gaming machine/kiosk. A user input interface 422 such as a mouse, keyboard/keypad, microphone, touch pad, trackball, joystick, touch screen, voice-recognition system, etc. may be provided.

The computing arrangement 600 may be connected to other computing devices or gaming machines, such as via a network. The computing arrangement 600 may be connected to a network server 628 in an intranet or local network configuration. The computer may further be part of a larger network configuration as in a global area network (GAN) such as the Internet. In such a case, the computer accesses one or more web servers 630 via the network/Internet 632.

Other components directed to gaming machine implementations include manners of gaming participant payment, and gaming machine payout. For example, a gaming machine including the computing arrangement 600 may also include a hopper controller 642 to determine the amount of payout to be provided to the participant. The hopper controller may be integrally implemented with the processor 602, or alternatively as a separate hopper controller 642. A hopper 644 may also be provided in gaming machine embodiments, where the hopper serves as the mechanism holding the coins/tokens of the machine. The wager input module 846 represents any mechanism for accepting coins, tokens, coupons, bills, electronic fund transfer (EFT), tickets, credit cards, smart cards, membership cards, etc., for which a participant inputs a wager amount.

Additionally, the computing arrangement 600 may include a transmitter (TX) 650, and may include a receiver (RX) 652. These TX 650 and RX 652 components may be discrete components, or aggregated such as in the case of a transceiver. The receiver function provided by the RX 652 can be configured to receive information from any type of network, such as a local area network (LAN), wireless LAN (e.g., 802.11a/b/g), wired network (e.g., Internet), wireless network (e.g., Global System for Mobile Communications/General Packet Radio Service (GSM/GPRS), proximity networks (e.g., Bluetooth, peer-to-peer networks), and/or other wired/wireless network technologies. For example, the RX 652 may receive server-based information via the web server 630, server 628, etc. Information such as wager information or other data used by a server to establish or adjust the winning amounts can be provided to the appropriate server 628, 630 or other device or network entity via the TX 650.

It should also be recognized that the computing arrangement 600 of FIG. 6 may be implemented in a gaming apparatus, or in a server or other network entity that determines and provides functionality in accordance with the invention.

It should be noted that each of the embodiments described herein may be combined with any one or more of the other embodiments.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., slot machines involving poker or card games that could be played via table games).

What is claimed is:

1. A method comprising:
presenting symbols in a plurality of symbol locations;
determining whether any predetermined symbol location groups, which are distinct from established paylines in which a symbol paytable identifies winning payouts, respectively include matching symbols therein; and
providing a payout amount if one or more of the predetermined symbol location groups respectively includes the matching symbols therein.

2. The method of claim 1, wherein providing a payout amount comprises providing increasingly higher payout amounts for increasingly higher numbers of the predetermined symbol location groups that respectively include the matching symbols therein.

3. The method of claim 1, further comprising providing a plurality of the established paylines and the corresponding symbol paytable identifying winning symbol combinations that provide standard payouts for occurrences of the identified winning symbol combinations on the established paylines.

4. The method of claim 1, wherein providing a payout amount comprises providing a first multiplier value if one of the predetermined symbol location groups includes the matching symbols, and multiplying the first multiplier value by an amount wagered.

5. The method of claim 4, wherein providing a payout amount comprises providing a second multiplier value if two of the predetermined symbol location groups includes matching symbols, and multiplying the second multiplier value by an amount wagered.

6. The method of claim 5, wherein the second multiplier value comprises a greater value than the first multiplier value.

7. The method of claim 1, wherein providing a payout amount comprises providing a first multiplier value if one of the predetermined symbol location groups includes the matching symbols, and multiplying the first multiplier value by a standard payout resulting from one or more symbol combinations occurring on paylines that correspond to winning symbol combinations on a standard paytable.

8. The method of claim 7, wherein providing a payout amount comprises providing a second multiplier value if two of the predetermined symbol location groups include matching symbols, and multiplying the second multiplier value by the standard payout resulting from one or more symbol combinations occurring on paylines that correspond to winning symbol combinations on a standard paytable.

9. The method of claim 8, wherein the second multiplier value comprises a greater value than the first multiplier value.

10. The method of claim 1, wherein providing a payout amount comprises providing respective predetermined payouts for each of the respective symbol location groups that include matching symbols therein.

11. The method of claim 1, wherein determining whether any predetermined symbol location groups respectively include matching symbols comprises determining whether each of the symbol location groups respectively includes like symbols therein, regardless of what particular symbol is alike in the respective symbol location group.

12. The method of claim 1, wherein determining whether any predetermined symbol location groups respectively include matching symbols comprises determining whether each of the symbol location groups respectively includes like symbols therein, regardless of whether the particular symbol that is alike in the respective symbol location group is available in winning symbol combinations on the established paylines.

13. The method of claim 1, further comprising defining one or more of the predetermined symbol location groups as vertical lines of the symbol locations.

14. The method of claim 1, further comprising defining one or more of the predetermined symbol location groups as horizontal lines of the symbol locations.

15. The method of claim 1, further comprising defining one or more of the predetermined symbol location groups as diagonal lines of the symbol locations.

16. The method of claim 1, further comprising defining one or more of the predetermined symbol location groups as predetermined patterns of the symbol locations.

17. The method of claim 1, wherein the payout value is the same regardless of which symbol proved to be the matching symbol in the respective symbol location group.

18. A method comprising:
establishing one or more paylines, on which consecutive like symbols presented in symbol locations and matching those identified via a paytable will produce a winning result;
presenting symbols in a plurality of the symbol locations;
determining whether a first payout value is awarded based on whether any of the consecutive like symbols were presented on the established paylines that match those identified in the paytable;
determining whether a second payout value is awarded based on whether a plurality of any matching symbols was presented in any of a plurality of predetermined symbol location groups, wherein the second payout value is the same regardless of the particular symbol that was matched in its respective symbol location group; and
providing a total payout based on at least any determined first payout value and any determined second payout value.

19. The method of claim 18, wherein the second payout value is mathematically applied to a wager value to provide a total second payout value, and wherein providing a total payout comprises providing the total payout based on at least any determined first payout value and the total second payout value.

20. The method of claim 18, wherein the second payout value is mathematically applied to the first payout value to arrive at the total payout.
